(19) United States
(12) Patent Application Publication
(10) Pub. No.: US 2025/0246739 A1
(43) Pub. Date: Jul. 31, 2025

(54) POWER STORAGE MODULE AND POWER STORAGE DEVICE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/015,636

(22) Filed: Jan. 10, 2025

(30) Foreign Application Priority Data
Jan. 26, 2024 (JP) 2024-009922

(51) Int. Cl. H01M 50/249; B60K 1/04; H01M 10/613; H01M 10/625; H01M 50/209; H01M 50/289

(52) U.S. Cl. CPC H01M 50/249; B60K 1/04; H01M 10/613; H01M 10/625; H01M 50/209; H01M 50/289; B60K 2001/0438; H01M 2220/20

(57) ABSTRACT

A power storage module includes a first stack and a second stack alternately disposed side by side in a first direction, wherein the first stack includes a plurality of first unit cells arranged in the first direction, and the second stack includes a plurality of second unit cells arranged in an up-down direction orthogonal to the first direction.

### CROSS REFERENCE TO RELATED APPLICATIONS

This nonprovisional application is based on Japanese Patent Application No. 2024-009922 filed on Jan. 26, 2024 with the Japan Patent Office, the entire contents of which are hereby incorporated by reference.

### BACKGROUND

### Field

The present disclosure relates to a power storage module, and a power storage device including the power storage module.

### Description of the Background Art

As a conventional power storage module, WO 2020/134054 discloses a configuration in which a plurality of unit cells are disposed side by side in a specified one direction.

### SUMMARY

In the configuration in which the plurality of unit cells are disposed side by side in one direction as disclosed in WO 2020/134054, side surfaces of the unit cells each having the largest area are disposed side by side in a first direction. When a specified unit cell generates heat, a side surface thereof expands in the first direction and the heat is sequentially transmitted to the unit cells from the side closer to first unit cell 211 that has generated the heat to the side farther from first unit cell 211. Therefore, it is concerned that the heat is transmitted to the plurality of unit cells over a wide range in the first direction.

The present disclosure has been made in view of the above-described problem, and an object of the present disclosure is to provide a power storage module capable of suppressing heat transmission to the entire power storage module when a specified unit cell generates heat, and a power storage device including the power storage module.

A power storage module according to the present disclosure includes a first stack and a second stack alternately disposed side by side in a first direction. The first stack includes a plurality of first unit cells arranged in the first direction. The second stack includes a plurality of second unit cells arranged in an up-down direction orthogonal to the first direction.

Generally, when a unit cell generates heat, a central portion (antinode) of the unit cell expands and the heat is transmitted to a unit cell disposed next to that unit cell.

According to the above-described configuration, since the first stack and the second stack that are different in stacking direction are alternately disposed, a direction of antinodes of the first unit cells included in the first stack can be made different from a direction of antinodes of the second unit cells included in the second stack. As a result, heat transmission between the first stack and the second stack can be suppressed.

In the power storage module according to the present disclosure described above, in the first stack and the second stack alternately disposed in the first direction, the first stack may be disposed at each of both ends in the first direction.

According to the above-described configuration, since the first stack in which the antinodes of the first unit cells are arranged in the first direction is disposed at each of both ends in the first direction, heat is likely to escape toward the outside in the first direction.

A power storage device according to the present disclosure includes: the above-described power storage module; and a cooler that cools the first stack and the second stack.

According to the above-described configuration, the first stack and the second stack can be cooled by the cooler.

In the power storage device according to the present disclosure, the cooler may be provided to extend in the first direction while passing through any gap between the first stack and the second stack and meandering in the up-down direction.

According to the above-described configuration, since the cooler is provided to extend in the first direction while meandering in the up-down direction, a surface facing upward or downward, of the second unit cells included in the second stack in the state of being stacked in the up-down direction, can be cooled by the cooler. In addition, a surface facing either one side or the other side in the first direction, of the first unit cells, can also be cooled by the cooler.

In the power storage device according to the present disclosure described above, each of the first stack and the second stack may include a plurality of side surfaces disposed around an axis orthogonal to the first direction and the up-down direction. In this case, the cooler may be provided in a meandering manner to cool two side surfaces of the plurality of side surfaces of the first stack and two side surfaces of the plurality of side surfaces of the second stack.

According to the above-described configuration, since the cooler is provided in a meandering manner, the first stack and the second stack can be cooled substantially uniformly. As a result, the occurrence of heat distribution in the first stack and the second stack can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view of a vehicle including a power storage device according to a first embodiment.

FIG. 2 shows a state in which the power storage device according to the first embodiment is fixed to the vehicle.

FIG. 3 is a schematic exploded perspective view of the power storage device according to the first embodiment.

FIG. 4 is a schematic perspective view showing a power storage module and a cooler in the power storage device according to the first embodiment.

FIG. 5 is a schematic view showing movement of heat when a specified unit cell generates the heat in the power storage module according to the first embodiment.

FIG. 6 is a schematic view showing movement of heat when a specified unit cell generates the heat in a power storage module according to a comparative embodiment.

FIG. 7 is a schematic view of a power storage module and a cooler in a power storage device according to a second embodiment, when viewed from one side in a second direction.

FIG. 8 is a schematic plan view of the power storage module and the cooler in the power storage device according to the second embodiment, when viewed from above.

### DESCRIPTION OF THE PREFERRED EMBODIMENTS

Hereinafter, embodiments of the present disclosure will be described in detail with reference to the drawings. In the embodiments described below, the same or corresponding portions are denoted by the same reference characters in the drawings, and description thereof will not be repeated.

### First Embodiment

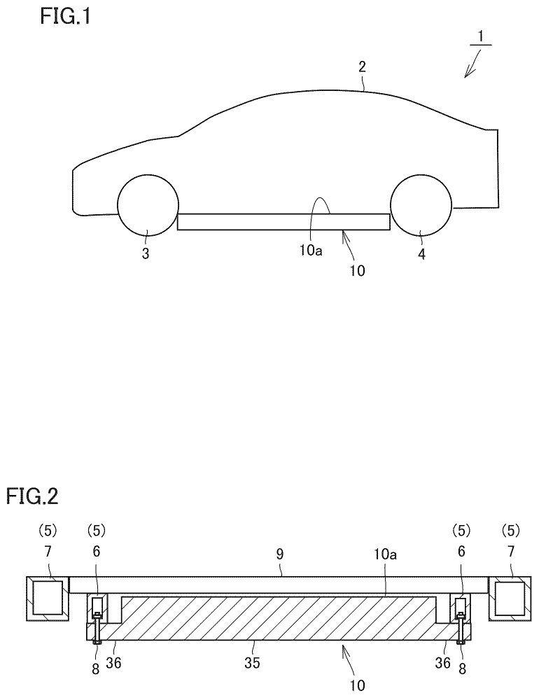

FIG. 1 is a schematic view of a vehicle including a power storage device according to a first embodiment. FIG. 2 shows a state in which the power storage device according to the first embodiment is fixed to the vehicle. A vehicle 1 according to the first embodiment will be described with reference to FIGS. 1 and 2.

Vehicle 1 is a hybrid vehicle that can travel using motive power of at least one of a motor and an engine, or an electrically powered vehicle that travels using driving force obtained by electrical energy.

Vehicle 1 includes a vehicle main body 2, a front wheel 3, a rear wheel 4, and a power storage device 10. Vehicle main body 2 includes a frame member 5. Power storage device 10 has an upper surface 10a. Upper surface 10a also functions as a floor member that defines a vehicle interior.

Frame member 5 includes a pair of side members 6 and a pair of side sills 7. The pair of side sills 7 are disposed at both ends in a width direction of vehicle 1. The pair of side members 6 are disposed inside the pair of side sills 7 with a distance therebetween. The pair of side members 6 and the pair of side sills 7 extend along a front-back direction of vehicle 1.

The pair of side members 6 are spaced apart from each other in the width direction of vehicle 1. A main body portion 35 of power storage device 10 is disposed in a gap between the pair of side members 6. A void space is provided between main body portion 35 and the pair of side members 6. As a result, even when vehicle 1 experiences side collision, input of the impact to power storage device 10 can be suppressed.

Fixed portions 36 are provided on both side surfaces of main body portion 35 in the width direction of vehicle 1. Fixed portions 36 are fixed to the pair of side members 6 by fastening members 8, respectively.

Frame member 5 also includes a cross member 9. Cross member 9 is provided above power storage device 10 to extend from one side sill 7 to the other side sill 7. Upper surface 10a of power storage device 10 is fixed to cross member 9.

Although the example in which frame member 5 includes the pair of side members 6 and the pair of side sills 7 has been illustrated and described above, the present disclosure is not limited thereto. The pair of side sills 7 may have the function of the pair of side members 6. In this case, the pair of side members 6 can be omitted and fixed portions 36 described above may be fixed to the pair of side sills 7.

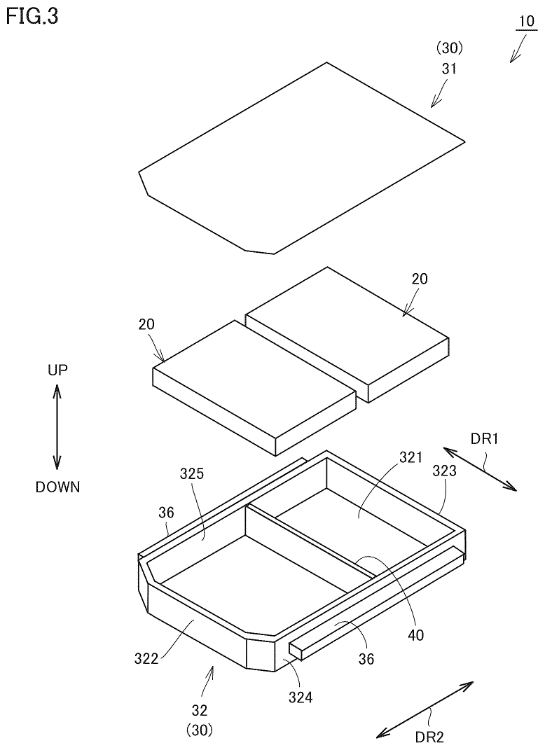

FIG. 3 is a schematic exploded perspective view of the power storage device according to the first embodiment. A detailed configuration of power storage device 10 will be described with reference to FIG. 3.

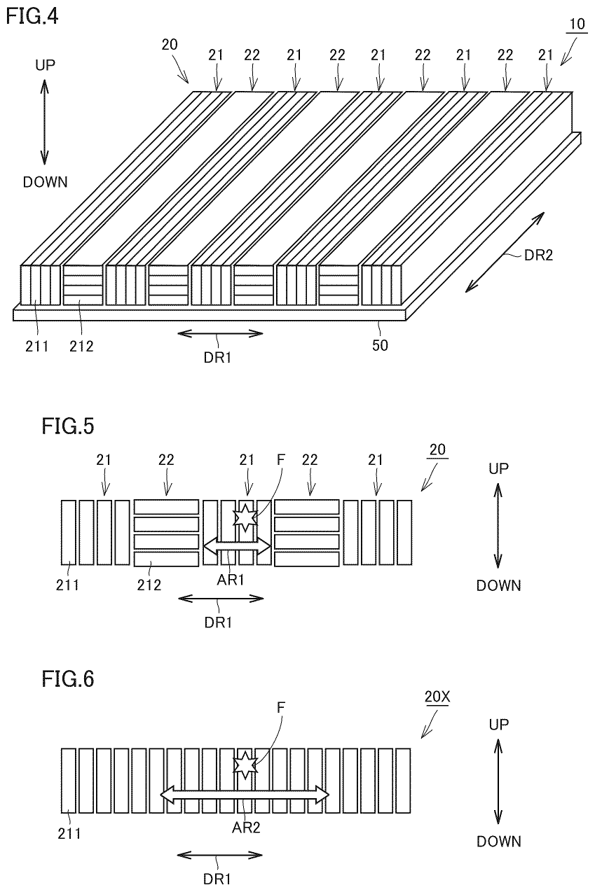

Power storage device 10 includes a plurality of power storage modules 20, an accommodation case 30, a partition member 40, and a cooler 50 (see FIG. 4).

The plurality of power storage modules 20 are disposed side by side in a second direction (DR2 direction) orthogonal to the first direction (DR1 direction) and the up-down direction. The up-down direction is orthogonal to the first direction. The first direction is, for example, parallel to a left-right direction of vehicle 1 in a mounted state in which power storage device 10 is mounted on vehicle 1. The second direction is parallel to the front-rear direction of vehicle 1 in the above-described mounted state. The up-down direction is parallel to a vertical direction and is parallel to the up-down direction of vehicle 1.

Each of power storage modules 20 includes a plurality of unit cells. A bus bar module is provided on each of one side and the other side of power storage module 20 in the first direction, and the plurality of unit cells are connected in series by the bus bar modules. The plurality of power storage modules 20 are also connected in series.

Accommodation case 30 includes an upper member 31 and a lower member 32. Lower member 32 has a substantially box shape that is opened upward. Lower member 32 includes main body portion 35 and fixed portions 36. Main body portion 35 has a bottom wall portion 321, a first wall portion 322, a second wall portion 323, and side wall portions 324 and 325. First wall portion 322, second wall portion 323, and side wall portions 324 and 325 are provided to rise from a perimeter edge of bottom wall portion 321.

First wall portion 322 and second wall portion 323 face each other in the second direction. Side wall portions 324 and 325 face each other in the first direction. Fixed portions 36 are provided on outer surfaces of side wall portions 324 and 325.

Partition member 40 is provided to partition an accommodation space in accommodation case 30. Specifically, partition member 40 is provided to extend in the first direction, and divides the accommodation space in accommodation case 30 in the second direction. Partition member 40 divides a region where power storage modules 20 are disposed. Power storage module 20 is disposed in each region divided by partition member 40.

Upper member 31 has a substantially flat plate shape. Upper member 31 covers the plurality of power storage modules 20 and closes an open space of lower member 32. A sealing member may be filled into a gap between upper member 31 and power storage modules 20. The sealing member may have insulating properties.

FIG. 4 is a schematic perspective view showing the power storage module and the cooler in the power storage device according to the first embodiment.

As shown in FIG. 4, power storage module 20 includes a plurality of first stacks 21 and a plurality of second stacks 22. The number of first stacks 21 and second stacks 22 can be set as appropriate, depending on the size of vehicle 1. The number of first stacks 21 and second stacks 22 is not limited to two or more, and may be one only.

The plurality of first stacks 21 and the plurality of second stacks 22 are alternately disposed in the first direction. Each of first stacks 21 includes a plurality of first unit cells 211 arranged in the first direction. Each of second stacks 22 includes a plurality of second unit cells 212 arranged in the up-down direction.

Each of first unit cells 211 and second unit cells 212 has an elongated shape in which the second direction is a longitudinal direction. Each of first unit cells 211 has a flat rectangular parallelepiped shape having a thickness in the first direction. Each of second unit cells 212 has a flat rectangular parallelepiped shape having a thickness in the up-down direction.

Each of first unit cells 211 and each of second unit cells 212 may be configured by the same unit cell. In this case, the number of components can be reduced, and the manufacturing cost can be reduced. It should be noted that “same” encompasses a unit cell including manufacturing errors such as tolerance. Alternatively, each of first unit cells 211 and each of second unit cells 212 may be configured by different unit cells.

Each of first unit cells 211 and second unit cells 212 is, for example, a secondary battery such as a nickel-metal hydride battery or a lithium ion battery. Each of first unit cells 211 and second unit cells 212 may be a unit cell including a liquid electrolyte, or may be a unit cell including a solid electrolyte. Each of first unit cells 211 and second unit cells 212 may be a chargeable and dischargeable capacitor.

Each of first unit cells 211 and second unit cells 212 has a first end face and a second end face on one side and the other side in the second direction. The first end face of each of first unit cells 211 and second unit cells 212 faces above-described side wall portion 324. The second end face of each of first unit cells 211 and second unit cells 212 faces above-described side wall portion 325.

First stacks 21 are disposed at both ends of power storage module 20 in the first direction. That is, in first stacks 21 and second stacks 22 alternately disposed in the first direction, first stacks 21 are disposed at both ends in the first direction. In such a case, a central portion (antinode) of a side surface of first unit cell 211 having the largest area as described below is exposed to a gap between first unit cell 211 and side wall portion 324, 325, and thus, heat is likely to escape toward the outside in the first direction. As a result, the heat dissipation performance of power storage module 20 can be enhanced.

Cooler 50 is disposed below power storage module 20, for example. Cooler 50 is provided to cool power storage module 20. Specifically, a refrigerant flow path through which refrigerant for cooling power storage module 20 flows is, for example, provided in cooler 50. Cooler 50 has a shape extending in a plane direction orthogonal to the up-down direction. Cooler 50 may be disposed above power storage module 20.

Cooler 50 may be in direct contact with power storage module 20, or may be in thermal contact with power storage module 20 through a thermally conductive member having high thermal conductivity. The thermally conductive member may be an adhesive containing a silicone-based resin, an acrylic resin, a urethane resin, or an epoxy resin.

FIG. 5 is a schematic view showing movement of heat when a specified unit cell generates the heat in the power storage module according to the first embodiment.

As shown in FIG. 5, in each of first stacks 21, side surfaces of first unit cells 211 each having the largest area are arranged in the first direction. On the other hand, in each of second stacks 22, side surfaces of second unit cells 212 each having the largest area are arranged in the up-down direction.

When a unit cell generates heat, a central portion (antinode) of a side surface having the largest area expands in the thickness direction (the first direction in first unit cell 211 and the up-down direction in second unit cell 212), and the heat is transmitted to a unit cell disposed next to that unit cell.

In the present embodiment, first stacks 21 and second stacks 22 that are different in stacking direction are alternately disposed, and thus, a direction of the antinodes of first unit cells 211 included in first stacks 21 can be made different from a direction of the antinodes of second unit cells 212 included in second stacks 22.

Therefore, when specified first unit cell 211 in first stack 21 generates heat (when heat is generated at a position indicated by “F” in the figure), the heat is transmitted as shown by an arrow AR1 in this first stack 21. However, the antinode of first unit cell 211 disposed at each of both ends in the first direction does not come close to the antinode of second unit cell 212 in second stack 22 but comes close to the side surface of second unit cell 212 having a small area. As a result, heat transmission from first stack 21 to second stack 22 is suppressed. Furthermore, since the antinode of second stack 22 faces in the up-down direction, the heat is less likely to be transmitted from second stack 22 to first unit cell 211 located opposite to first stack 21 including first unit cell 211 that has generated the heat. In this way, heat transmission between first stacks 21 and second stacks 22 can be suppressed, and heat transmission to entire power storage module 20 can be suppressed.

### Comparative Embodiment

FIG. 6 is a schematic view showing movement of heat when a specified unit cell generates the heat in a power storage module according to a comparative embodiment. Movement of heat in a power storage module 20X according to the comparative embodiment will be described with reference to FIG. 6.

As shown in FIG. 6, power storage module 20X according to the comparative embodiment does not include second stack 22 and is formed by arranging a plurality of first unit cells 211 in the first direction. In such a case, in the plurality of first unit cells 211, side surfaces of first unit cells 211 each having the largest area are continuously disposed side by side in the first direction. Therefore, when specified first unit cell 211 generates heat (when heat is generated at a position indicated by “F” in the figure), the heat is sequentially transmitted from first unit cell 211 located on the side closer to first unit cell 211 that has generated the heat to first unit cell 211 located on the side farther from first unit cell 211 that has generated the heat, through the side surfaces each having the largest area, as shown by an arrow AR2. As a result, the heat is more likely to be transmitted to entire power storage module 20X in the comparative embodiment than in the first embodiment.

### Second Embodiment

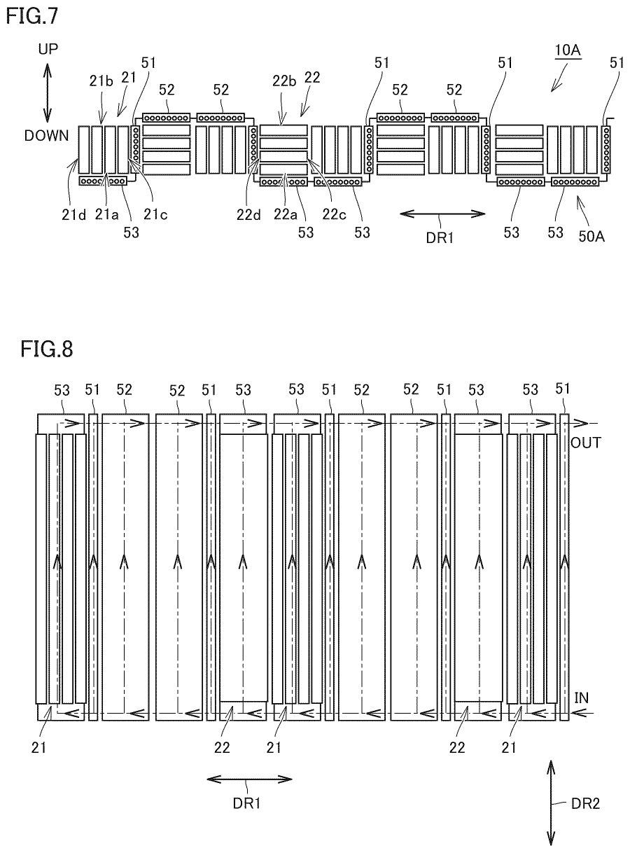

FIG. 7 is a schematic view of a power storage module and a cooler in a power storage device according to a second embodiment, when viewed from one side in the second direction. FIG. 8 is a schematic plan view of the power storage module and the cooler in the power storage device according to the second embodiment, when viewed from above. A power storage device 10A according to the second embodiment will be described with reference to FIGS. 7 and 8.

As shown in FIGS. 7 and 8, power storage device 10A according to the second embodiment is different from power storage device 10 according to the first embodiment in terms of a configuration of a cooler 50A. Power storage device 10A according to the second embodiment is otherwise substantially the same as power storage device 10 according to the first embodiment.

Each of first stacks 21 includes a plurality of side surfaces 21a, 21b, 21c, and 21d disposed around an axis orthogonal to the first direction (DR1) and the up-down direction. The axis orthogonal to the first direction and the up-down direction is parallel to the second direction. Side surfaces 21a and 21b face each other in the up-down direction, and side surfaces 21c and 21d face each other in the first direction.

Each of second stacks 22 includes a plurality of side surfaces 22a, 22b, 22c, and 22d disposed around the axis orthogonal to the first direction and the up-down direction. Side surfaces 22a and 22b face each other in the up-down direction, and side surfaces 22c and 22d face each other in the first direction.

Cooler 50A is provided in a meandering manner to cool two side surfaces of the plurality of side surfaces 21a, 21b, 21c, and 21d of first stack 21 and two side surfaces of the plurality of side surfaces 22a, 22b, 22c, and 22d of second stack 22. The above-described two side surfaces are side surfaces orthogonal to each other. Above-described side surfaces 21c and 21d are configured by side surfaces each having the largest area, of the side surfaces of first unit cell 211. Above-described side surfaces 22a and 22b are configured by side surfaces each having the largest area, of the side surfaces of second unit cell 212.

Cooler 50A has a plurality of first cooling portions 51, a plurality of second cooling portions 52, and a plurality of third cooling portions 53. First cooling portions 51, second cooling portions 52 and third cooling portions 53 are provided to extend in the second direction. A refrigerant flow path through which refrigerant can flow is provided in each of first cooling portions 51, second cooling portions 52 and third cooling portions 53, and the refrigerant flows through each of the cooling portions as shown by an arrow in FIG. 8.

The plurality of first cooling portions 51 are spaced apart from each other in the first direction. First stack 21 and second stack 22 are disposed between two first cooling portions 51 adjacent to each other in the first direction. First cooling portion 51 is disposed in every other gap, of the gaps between first stacks 21 and second stacks 22 arranged in the first direction. First cooling portion 51 cools side surface 21c of first stack 21 and side surface 22d of second stack 22.

The plurality of second cooling portions 52 are disposed above first stacks 21 and second stacks 22. The plurality of third cooling portions 53 are disposed below first stacks 21 and second stacks 22. The plurality of second cooling portions 52 and the plurality of third cooling portions 53 are disposed such that two second cooling portions 52 and two third cooling portions 53 are alternately aligned on the upper and lower sides along the first direction.

Since cooler 50A is provided in a meandering manner as described above, first stacks 21 and second stacks 22 can be cooled substantially uniformly. As a result, the occurrence of heat distribution in first stacks 21 and second stacks 22 can be suppressed.

Although the example in which cooler 50A is provided in a meandering manner to cool two side surfaces of each first stack 21 and two side surfaces of each second stack 22 has been illustrated above, the present disclosure is not limited thereto. The cooler may be provided to extend in the first direction while passing through any gaps between first stacks 21 and second stacks 22 and meandering in the up-down direction. As a result, a surface facing upward or downward, of second unit cells 212 included in each second stack 22 in the state of being stacked in the up-down direction, can be cooled by the cooler. In addition, a surface facing either one side or the other side in the first direction, of first unit cells 211, can also be cooled by the cooler.

For example, first cooling portion 51 may be disposed in every gap between first stack 21 and second stack 22 adjacent to each other, and the cooler may be provided in a meandering manner to cool three side surfaces of the plurality of side surfaces 21a, 21b, 21c, and 21d of first stack 21 and three side surfaces of the plurality of side surfaces 22a, 22b, 22c, and 22d of second stack 22. In this case as well, first stacks 21 and second stacks 22 can be cooled substantially uniformly.

### Other Modifications

Although the example in which the first direction in which first stacks 21 and second stacks 22 are alternately disposed is parallel to the width direction of vehicle 1 has been illustrated and described in the first and second embodiments above, the present disclosure is not limited thereto. The above-described first direction may be parallel to the left-right direction of vehicle 1 in the above-described mounted state. In this case, the above-described second direction is parallel to the front-rear direction of the vehicle in the above-described mounted state.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage module comprising a first stack and a second stack alternately disposed side by side in a first direction, wherein
the first stack includes a plurality of first unit cells arranged in the first direction, and
the second stack includes a plurality of second unit cells arranged in an up-down direction orthogonal to the first direction.

2. The power storage module according to claim 1, wherein
in the first stack and the second stack alternately disposed in the first direction, the first stack is disposed at each of both ends in the first direction.

3. A power storage device comprising:
the power storage module as recited in claim 1; and
a cooler that cools the first stack and the second stack.

4. The power storage device according to claim 3, wherein
the cooler is provided to extend in the first direction while passing through any gap between the first stack and the second stack and meandering in the up-down direction.

5. The power storage device according to claim 4, wherein
each of the first stack and the second stack includes a plurality of side surfaces disposed around an axis orthogonal to the first direction and the up-down direction, and
the cooler is provided in a meandering manner to cool two side surfaces of the plurality of side surfaces of the first stack and two side surfaces of the plurality of side surfaces of the second stack.
